(19) United States
(12) Patent Application Publication
(10) Pub. No.: US 2017/0077605 A1
(43) Pub. Date: Mar. 16, 2017

(54) ANTENNA ARRANGEMENT

(71) Applicant: Microsoft Technology Licensing, LLC, Redmond, WA (US)

(72) Inventor: Jari Van Wonterghem, Tampere (FI)

(21) Appl. No.: 14/855,905

(22) Filed: Sep. 16, 2015

(51) Int. Cl. H01Q 5/378; H01Q 5/385; H01Q 9/04; H01Q 1/24

(52) U.S. Cl. CPC H01Q 5/378; H01Q 1/243; H01Q 5/385; H01Q 9/0442

(57) ABSTRACT

An apparatus comprises a parasitic radiative element, a tuning element having a galvanic coupling to the parasitic radiative element, and a driven radiative element having a non-galvanic coupling to the parasitic radiative element.

### BACKGROUND

When an apparatus needs to receive and/or transmit data wirelessly, the apparatus needs to implement a data receiver and/or data transmitter and an antenna arrangement. A single antenna may be used both to receive data and to transmit data. Alternatively, the apparatus may comprise separate antennas for receiving and transmitting data.

### SUMMARY

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

In one embodiment, an apparatus is provided. The apparatus comprises a parasitic radiative element, a tuning element having a galvanic coupling to the parasitic radiative element, and a driven radiative element having a non-galvanic coupling to the parasitic radiative element.

In another embodiment, an apparatus is provided. The apparatus comprises a housing comprising a metal ring, wherein at least part of the metal ring is configured to operate as a parasitic radiative element, a tuning element having a galvanic coupling to the parasitic radiative element, and a driven radiative element having a non-galvanic coupling to the parasitic radiative element.

In another embodiment, a mobile wireless communication apparatus is provided. The mobile wireless communication apparatus comprises a housing comprising a metal ring, wherein at least part of the metal ring is configured to operate as a parasitic radiative element, a tuning element having a galvanic coupling to the parasitic radiative element, and a driven radiative element having a non-galvanic coupling to the parasitic radiative element. The parasitic radiative element together with the tuning element is configured to provide a first frequency range and the driven radiative element is configured to provide a second frequency range.

Many of the attendant features will be more readily appreciated as they become better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a system diagram depicting an apparatus including a variety of optional hardware and software components.

FIG. 2 illustrates an embodiment of an apparatus for receiving and/or transmitting data.

FIG. 3A illustrates another embodiment of an apparatus for receiving and/or transmitting data.

FIG. 3B illustrates another embodiment of an apparatus for receiving and/or transmitting data.

FIG. 4A illustrates an embodiment of a tuning element.

FIG. 4B illustrates another embodiment of a tuning element.

FIG. 4C illustrates another embodiment of a tuning element.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples. Furthermore, as used in this application and in the claims, the singular forms “a,” “an,” and “the” include the plural forms unless the context clearly dictates otherwise. Additionally, the term “includes” means “comprises.” Further, the term “coupled” encompasses mechanical, electrical, magnetic, optical, as well as other practical ways of coupling or linking items together, and does not exclude the presence of intermediate elements between the coupled items.

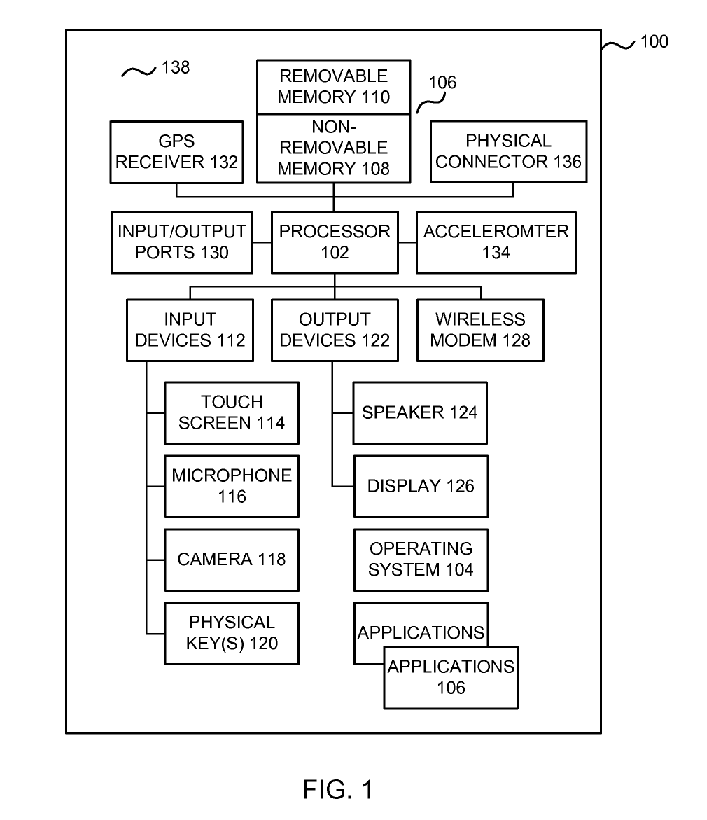

FIG. 1 is a system diagram depicting an apparatus 100 including a variety of optional hardware and software components, shown generally at 138. Any components 138 in the apparatus can communicate with any other component, although not all connections are shown, for ease of illustration. The apparatus can be any of a variety of computing devices (for example, a mobile device, a cell phone, a smartphone, a handheld computer, a tablet computer, a Personal Digital Assistant (PDA), etc.) and can allow wireless two-way communications with one or more communications networks, such as a cellular or satellite network.

The illustrated apparatus 100 can include a controller or processor 102 (e.g., signal processor, microprocessor, ASIC, or other control and processing logic circuitry) for performing such tasks as signal coding, data processing, input/output processing, power control, and/or other functions. An operating system 104 can control the allocation and usage of the components 138 and support for one or more application programs 106. The application programs can include common computing applications (for example, email applications, calendars, contact managers, web browsers, messaging applications), or any other computing application.

The illustrated apparatus 100 can include a memory 106. The memory 106 can include non-removable memory 108 and/or removable memory 110. The non-removable memory 108 can include RAM, ROM, flash memory, a hard disk, or other well-known memory storage technologies. The removable memory 110 can include flash memory or a Subscriber Identity Module (SIM) card, which is well known in GSM communication systems, or other well-known memory storage technologies, such as “smart cards.” The memory 106 can be used for storing data and/or code for running the operating system 104 and the applications 106. Example data can include web pages, text, images, sound files, video data, or other data sets to be sent to and/or received from one or more network servers or other devices via one or more wired or wireless networks. The memory 106 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The apparatus 100 can support one or more input devices 112, such as a touchscreen 114, microphone 116, camera 118 and/or physical keys or a keyboard 120 and one or more output devices 122, such as a speaker 124 and a display 126. Other possible output devices (not shown) can include piezoelectric or other haptic output devices. Some devices can serve more than one input/output function. For example, the touchscreen 114 and the display 126 can be combined in a single input/output device. The input devices 112 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 104 or applications 106 can comprise speech-recognition software as part of a voice user interface that allows a user to operate the apparatus 100 via voice commands. Further, the apparatus 100 can comprise input devices and software that allows for user interaction via a user's spatial gestures, such as detecting and interpreting gestures to provide input to a gaming application.

A wireless modem 128 can be coupled to an antenna (not shown) and can support two-way communications between the processor 102 and external devices, as is well understood in the art. The modem 128 is shown generically and can include a cellular modem for communicating with a mobile communication network and/or other radio-based modems (e.g., Bluetooth or Wi-Fi). The wireless modem 128 is typically configured for communication with one or more cellular networks, such as a GSM network for data and voice communications within a single cellular network, a WCDMA (Wideband Code Division Multiple Access) network, an LTE (Long Term Evolution) network, a 4G LTE network, between cellular networks, or between the apparatus and a public switched telephone network (PSTN) etc.

The apparatus 100 can further include at least one input/output port 130, a satellite navigation system receiver 132, such as a Global Positioning System (GPS) receiver, an accelerometer 134, and/or a physical connector 136, which can be a USB port, IEEE 1394 (FireWire) port, and/or RS-232 port. The illustrated components 138 are not required or all-inclusive, as any components can deleted and other components can be added.

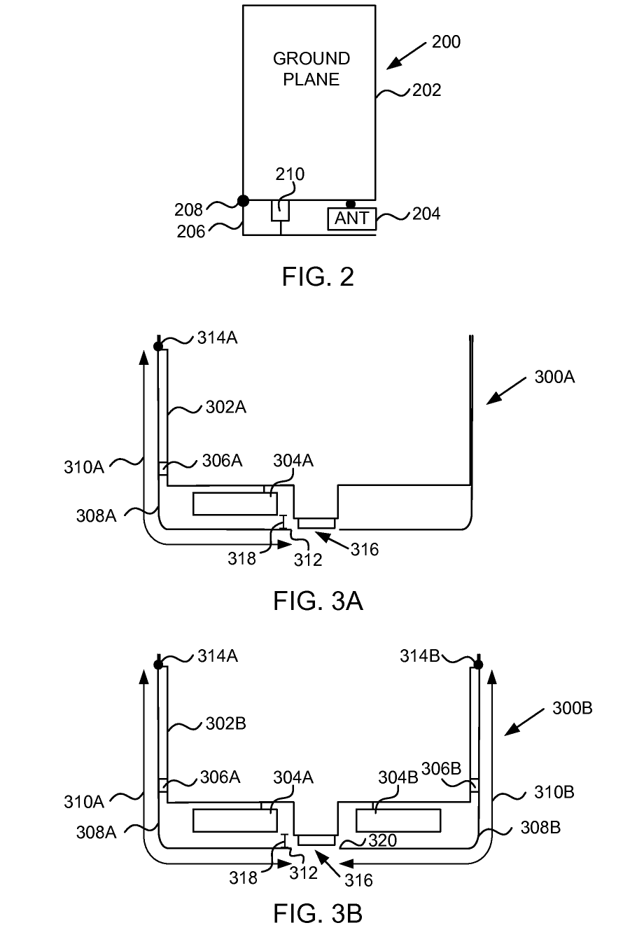

FIG. 2 illustrates an embodiment of an apparatus 200 for receiving and/or transmitting data. The apparatus 200 disclosed in FIG. 2 comprises a ground plane 202. The ground plane 202 may refer to a chassis or a main printed circuit board (PCB). The apparatus 200 comprises also a driven radiative element 204, for example, an antenna element. The driven radiative element 204 has a galvanic coupling to the ground plane 202. The apparatus 200 further comprises a parasitic radiative element 206. The purpose of the parasitic radiative element is to modify the radiation pattern of the radio waves emitted by the driven radiative element 204. This may mean that that the parasitic radiative element 206 acts as a passive resonator, absorbing the radio waves from the driven radiative element and re-radiating them again with a different phase. The parasitic radiative element 206 can be grounded to the ground plane at its one end at point 208. The driven radiative element 204 has a non-galvanic, for example, capacitive coupling to the parasitic radiative element 206.

The apparatus 200 comprises also a tuning element 210 having a galvanic coupling to the parasitic radiative element 206. By using the tuning element 210 it is possible to change the electrical behavior of the parasitic radiative element 206, for example, the resonance frequency. The parasitic radiative element 206 together with the tuning element 210 may be configured to provide a first frequency range and the driven radiative element 204 may be configured to provide a second frequency range.

The arrangement illustrated in FIG. 2 is simple and easy to implement. Further, the feeding point to the driven radiative element 204 may be arranged directly from the main printed circuit board.

FIG. 3A illustrates an embodiment of an apparatus 300A for receiving and/or transmitting data. The apparatus 300A is, for example, a mobile device or a smart phone or any other mobile electronic device. The apparatus 300A disclosed in FIG. 3A comprises a ground plane 302A. The ground plane 302A refers, for example, to a main printed circuit board (PCB) of apparatus 300A. The apparatus 300A comprises also a driven radiative element 304A, for example, an antenna. The driven radiative element 304A has a galvanic coupling to the main printed circuit board 302A.

The apparatus 300A further comprises a parasitic radiative element 308A. The purpose of the parasitic radiative element 308A is to modify the radiation pattern of the radio waves emitted by the driven radiative element 304A. This may mean that the parasitic radiative element 308A acts as a passive resonator, absorbing the radio waves from the driven radiative element and re-radiating them again with a different phase. The parasitic radiative element 308A may be grounded to the chassis providing a ground plane at its one end at point 314A. In this embodiment, the chassis refers, for example, to the combination of a metallic display frame and the main printed circuit board 302A.

The apparatus 300A comprises also a tuning element 306A having a galvanic coupling to the parasitic radiative element 308A. In this embodiment part of a metal housing ring of the apparatus 300A forms the parasitic radiative element 308A. The parasitic radiative element 308A starts from a grounding point 314A and ends to a split section 316 in the metal ring housing at a point 312, thus having a specific length indicated by reference 310A. The longer this length, the lower the first resonance frequency is. The split section 316 in the metal ring housing may be used to provide an input/output port for the apparatus 300A and to provide electrical isolation between the two structures. A reference 318 represents a separation distance between the parasitic radiative element 308A and the driven radiative element 304A. The smaller the distance, the stronger is the capacitive coupling and this impacts primarily the first frequency range by lowering it.

The parasitic radiative element 308A together with the tuning element 306A may be configured to provide a first frequency range and the driven radiative element 304A may be configured to provide a second frequency range. Further, it is also possible to use the parasitic radiative element 308A to enhance the second frequency range. In one embodiment, the first frequency range is approximately 699 MHz-960 MHz and the second frequency range is approximately 1710 MHz-2960 MHz of a Long Term Evolution (LTE) mobile communication network. In another embodiment, the frequency ranges provided by the parasitic radiative element 308A together with the tuning element 306A and the driven radiative element 304A may comprise television broadcast frequency ranges.

The arrangement illustrated in FIG. 3A is simple and easy to implement. Further, the feeding point to the driven radiative element 304A may be arranged directly from the main printed circuit board 302A.

FIG. 3B illustrates another embodiment of an apparatus for receiving and/or transmitting data. The apparatus 300B is, for example, a mobile device or a smart phone or any other mobile electronic device. The apparatus 300B disclosed in FIG. 3B comprises a ground plane 302A. The ground plane 302A refers, for example, to a main printed circuit board (PCB) of apparatus 300B. The apparatus 300B comprises also a driven radiative element 304A, for example, an antenna. The driven radiative element 304A has a galvanic coupling to the main printed circuit board 302A.

The apparatus 300B further comprises a parasitic radiative element 308A. The parasitic radiative element 308A may add additional frequency ranges and may also enhance the existing frequency ranges and modify the radiation pattern of the radio waves emitted by the driven radiative element 304A. This may mean that the parasitic radiative element 308A acts as a passive resonator, absorbing the radio waves from the driven radiative element and re-radiating them again with a different phase. The parasitic radiative element 308A is grounded to main printed circuit board 302A at its one end at point 314A.

The apparatus 300B comprises also a tuning element 306A having a galvanic coupling to the parasitic radiative element 308A. In this embodiment part of a metal housing ring of the apparatus 300B forms the parasitic radiative element 308A. The parasitic radiative element 308A starts from the grounding point 314A and ends to a split section 316 in the metal ring housing at a point 312, thus having a specific length indicated by reference 310A. The split section 316 in the metal ring housing may also be used to provide an input/output port for the apparatus 300B and electrical isolation between the two structures. A reference 318 represents a separation distance between the parasitic radiative element 308A and the driven radiative element 304A. The smaller the distance, the stronger is the capacitive coupling and this impacts primarily the first frequency range by lowering it.

The apparatus 300B further comprises a second tuning element 306B having a galvanic coupling to a second parasitic radiative element 308B. In this embodiment part of the metal housing ring forms the second parasitic radiative element 308B. The second parasitic radiative element 308B starts from the grounding point 314B and ends to the split section 316 in the metal ring housing at a point 320, thus having a specific length indicated by a reference 310B. The split section 316 in the metal ring housing may be used to provide an input/output port.

The parasitic radiative elements 308A, 308B together with the tuning elements 306A, 306B may be configured to provide a first frequency range and the driven radiative elements 304A, 304B may be configured to provide a second frequency range. In one embodiment, the first frequency range is approximately 699 MHz-960 MHz and the second frequency range is approximately 1710 MHz-2960 MHz. In another embodiment, the frequency ranges provided by the parasitic radiative elements 308A, 308B together with the tuning elements 306A, 306B and the driven radiative elements 304A, 304B may comprise television broadcast frequency ranges.

In another embodiment of FIG. 3B, there is no second tuning element 306B, but the parasitic radiative element 308B still operates at its natural frequency defined by the length 310B. The separation distance between the driven radiative elements 304B and the parasitic radiative element 308B also impact the parasitic operation frequency by lowering it.

The arrangement illustrated in FIG. 3B is simple and easy to implement. Further, the feeding point to the driven radiative elements 304A, 304B may be arranged directly from the main printed circuit board 302B.

Further, in the embodiments illustrated in FIGS. 3A and 3B, the parasitic radiative element 308A may also enhance the second frequency range generated by the driven radiative element 304A.

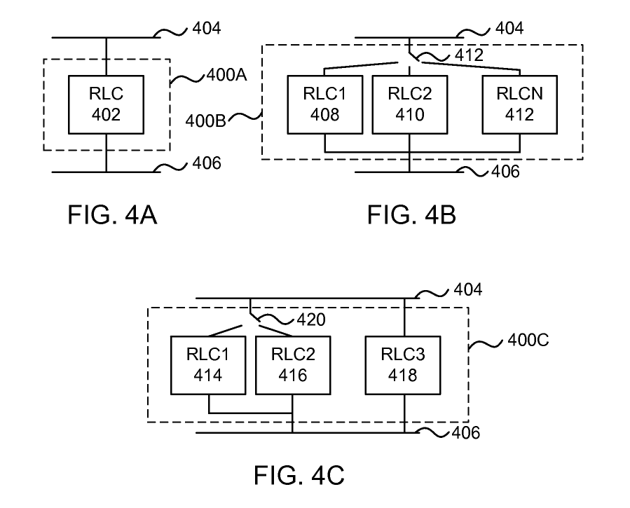

FIG. 4A illustrates an embodiment of a tuning element 400A that can be used in any of the embodiments illustrated in FIGS. 1, 2, 3A and 3B. The tuning element 400A is a passive tuning element and comprises an RLC circuit 402. A reference 404 represents a connection point to a ground plane or to a main circuit board. A reference 406 represents that the tuning element 400A has a galvanic coupling to a parasitic radiative element. FIG. 4A provides a passive tuning network which enables only a single, fixed portion of the first frequency range. This allows adjusting the frequency without changing mechanical dimensions 308A or 308B or the separation distance between the parasitic radiative element 308A or 308B and the driven radiative element 304A or 304B.

FIG. 4B illustrates an embodiment of a tuning element 400B that can be used in any of the embodiments illustrated in FIGS. 1, 2, 3A and 3B. The tuning element 400B is an active tuning element and comprises N RLC circuits 408, 410, 412. N can be any number being two or more. The tuning element 400B comprises a switch 412 enabling selection of any of the RLC circuits 408, 410, 412. The switch 412 may also be replaced with any other selector element that is able to select any of the RLC circuits 408, 410, 412.

A reference 404 represents a connection point to a ground plane or to a main circuit board. A reference 406 represents that the tuning element 400B has a galvanic coupling to a parasitic radiative element. FIG. 4B provides the full first frequency range by providing multiple tuning states using a switch 412.

FIG. 4C illustrates an embodiment of a tuning element 400C that can be used in any of the embodiments illustrated in FIGS. 1, 2, 3A and 3B. The tuning element 400C is both an active tuning element part and a passive tuning element part. The active tuning element part comprises two RLC circuits 414, 416, and a switch 420 is configured to provide switching between the two RLC circuits 414, 416. The switch 420 may also be replaced with any other selector element that is able to select any of the RLC circuits 414, 416. The passive tuning element part comprises one RLC circuit 418. In another embodiment, the number of RLC circuits in the active tuning element part and the passive tuning element part may be different than illustrated in FIG. 4C. FIG. 4C has also an additional, parallel passive tuning circuit. This can be used for example to reduce the number of switchable tuning states, which can be useful, for example, in case of regional variants that may need to cover different operation frequency ranges.

A reference 404 represents a connection point to a ground plane or to a main circuit board. A reference 406 represents that the tuning element 400C has a galvanic coupling to a parasitic radiative element.

According to an aspect, there is provided an apparatus comprising a parasitic radiative element; a tuning element having a galvanic coupling to the parasitic radiative element, and a driven radiative element having a non-galvanic coupling to the parasitic radiative element

In one embodiment, the driven radiative element is capacitively coupled to the parasitic radiative element.

In another embodiment, alternatively or in addition, the tuning element comprises at least one of a passive tuning element and an active tuning element.

In another embodiment, alternatively or in addition, the tuning element comprises at least one RLC circuit.

In another embodiment, alternatively or in addition, the apparatus further comprises a switch, wherein the tuning element comprises a plurality of RLC circuits and the switch is configured to switch between the plurality of RLC circuits.

In another embodiment, alternatively or in addition, the apparatus further comprises a switch, wherein the tuning element comprises a passive RLC circuit and an active RLC circuit, wherein the active RLC circuit comprises a plurality of RLC circuits and the switch is configured to switch between the plurality of RLC circuits.

In another embodiment, alternatively or in addition, the parasitic radiative element together with the tuning element is configured to provide a first frequency range and the driven radiative element is configured to provide a second frequency range.

In another embodiment, alternatively or in addition, the parasitic radiative element and the driven radiative element are configured to provide at least one frequency band for a mobile communication network.

In another embodiment, alternatively or in addition, the parasitic radiative element and the driven radiative element are configured to provide at least one frequency band for a broadcast network.

In another embodiment, alternatively or in addition, the parasitic radiative element comprises part of a metal housing ring of the apparatus.

In another embodiment, alternatively or in addition, the apparatus further comprises a second parasitic radiative element, a second tuning element having a galvanic coupling to the second parasitic radiative element, and a second driven radiative element having a non-galvanic coupling to the second parasitic radiative element.

In another embodiment, alternatively or in addition the parasitic radiative element and the second parasitic radiative element comprise separate parts of a metal housing ring of the apparatus, wherein a split on the metal housing ring separates the parts.

In another embodiment, alternatively or in addition, the apparatus comprises a mobile wireless communication device.

According to another aspect, there is provided an apparatus comprising a housing comprising a metal ring, wherein at least part of the metal ring is configured to operate as a parasitic radiative element, a tuning element having a galvanic coupling to the parasitic radiative element, and a driven radiative element having a non-galvanic coupling to the parasitic radiative element.

In one embodiment, the tuning element comprises at least one of a passive tuning element and an active tuning element.

In another embodiment, alternatively or in addition, the tuning element comprises at least one RLC circuit.

In another embodiment, alternatively or in addition, the apparatus further comprises a switch, wherein the tuning element comprises a plurality of RLC circuits and the switch is configured to switch between the plurality of RLC circuits.

In another embodiment, alternatively or in addition, a second part of the metal ring is configured to operate as a second parasitic radiative element; wherein the apparatus further comprises a second tuning element having a galvanic coupling to the second parasitic radiative element and a second driven radiative element having a non-galvanic coupling to the second parasitic radiative element.

In another embodiment, alternatively or in addition, the parasitic radiative element together with the tuning element is configured to provide a first frequency range and the driven radiative element is configured to provide a second frequency range.

According to another aspect, there is provided an apparatus comprising a housing comprising a metal ring, wherein at least part of the metal ring is configured to operate as a parasitic radiative element, a tuning element having a galvanic coupling to the parasitic radiative element, a driven radiative element having a non-galvanic coupling to the parasitic radiative element, and wherein the parasitic radiative element together with the tuning element is configured to provide a first frequency range and the driven radiative element is configured to provide a second frequency range.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs).

Although the subject matter may have been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages.

Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification. In particular, the individual features, elements, or parts described in the context of one example, may be connected in any combination to any other example also.

1. An apparatus, comprising:
a parasitic radiative element;
a tuning element having a galvanic coupling to the parasitic radiative element; and
a driven radiative element having a non-galvanic coupling to the parasitic radiative element.

2. An apparatus according to claim 1, wherein the driven radiative element is capacitively coupled to the parasitic radiative element.

3. An apparatus according to claim 1, wherein the tuning element comprises at least one of a passive tuning element and an active tuning element.

4. An apparatus according to claim 1, wherein the tuning element comprises at least one RLC circuit.

5. An apparatus according to claim 1, further comprising a switch, wherein the tuning element comprises a plurality of RLC circuits and the switch is configured to switch between the plurality of RLC circuits.

6. An apparatus according to claim 1, further comprising a switch, wherein the tuning element comprises a passive RLC circuit and an active RLC circuit, wherein the active RLC circuit comprises a plurality of RLC circuits and the switch is configured to switch between the plurality of RLC circuits.

7. An apparatus according to claim 1, wherein the parasitic radiative element together with the tuning element is configured to provide a first frequency range and the driven radiative element is configured to provide a second frequency range.

8. An apparatus according to claim 1, wherein the parasitic radiative element and the driven radiative element are configured to provide at least one frequency band for a mobile communication network.

9. An apparatus according to claim 1, wherein the parasitic radiative element and the driven radiative element are configured to provide at least one frequency band for a broadcast network.

10. An apparatus according to claim 1, wherein the parasitic radiative element comprises part of a metal housing ring of the apparatus.

11. An apparatus according to claim 1, further comprising:
a second parasitic radiative element;
a second tuning element having a galvanic coupling to the second parasitic radiative element; and
a second driven radiative element having a non-galvanic coupling to the second parasitic radiative element.

12. An apparatus according to claim 11, wherein the parasitic radiative element and the second parasitic radiative element comprise separate parts of a metal housing ring of the apparatus, wherein a split on the metal housing ring separates the parts.

13. An apparatus according to claim 1, wherein the apparatus comprises a mobile wireless communication device.

14. An apparatus, comprising:
a housing comprising a metal ring, wherein at least part of the metal ring is configured to operate as a parasitic radiative element;
a tuning element having a galvanic coupling to the parasitic radiative element; and
a driven radiative element having a non-galvanic coupling to the parasitic radiative element.

15. An apparatus according to claim 14, wherein the tuning element comprises at least one of a passive tuning element and an active tuning element.

16. An apparatus according to claim 14, wherein the tuning element comprises at least one RLC circuit.

17. An apparatus according to claim 14, further comprising a switch, wherein the tuning element comprises a plurality of RLC circuits and the switch is configured to switch between the plurality of RLC circuits.

18. An apparatus according to claim 14, wherein a second part of the metal ring is configured to operate as a second parasitic radiative element; wherein the apparatus further comprises
a second tuning element having a galvanic coupling to the second parasitic radiative element; and
a second driven radiative element having a non-galvanic coupling to the second parasitic radiative element.

19. An apparatus according to claim 14, wherein the parasitic radiative element together with the tuning element is configured to provide a first frequency range and the driven radiative element is configured to provide a second frequency range.

20. A mobile wireless communication apparatus, comprising:
a housing comprising a metal ring, wherein at least part of the metal ring is configured to operate as a parasitic radiative element;
a tuning element having a galvanic coupling to the parasitic radiative element;
a driven radiative element having a non-galvanic coupling to the parasitic radiative element; and
wherein the parasitic radiative element together with the tuning element is configured to provide a first frequency range and the driven radiative element is configured to provide a second frequency range.
